(19) United States
(12) Patent Application Publication
(10) Pub. No.: US 2007/0028539 A1
(43) Pub. Date: Feb. 8, 2007

(54) Snap-on colored window moldings

(76) Inventors: Steven Ray Peabody, Zionsville, IN (US); William James Newark, Sugarcreek, OH (US)

Correspondence Address: RICHARD L HUFF, 19304 OLNEY MILL ROAD, OLNEY, MD, 20832, US

(21) Appl. No.: 11/194,705

(22) Filed: Aug. 2, 2005

(51) Int. Cl. E06B 3/00

(52) U.S. Cl. 52/204.55

(57) ABSTRACT

Replacement moldings which cover window sashes and frames. The moldings may be of custom colors and sizes. The moldings fit over existing sashes and frames and snap into place. The sash molding comprises a longitudinal strip containing a horizontal top ledge, an integral vertical exterior wall ending in an inwardly extending flange, and an inwardly and downwardly curved connection piece extending from the exterior wall. The frame molding comprises a longitudinal strip containing a vertical upper flange, a horizontal top ledge, and an integral exterior wall ending in an inwardly extending lower flange. The exterior wall is substantially vertical having a slight inward slant following that of the contour of the underlying frame.

### CROSS-REFERENCE TO RELATED APPLICATIONS

This disclosure discloses subject matter originally disclosed in the inventors' prior application, Ser. No. ______ filed ______.

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1. Field of the Invention

The field of the invention is snap-on colored moldings for windows which allow the user to quickly and easily apply a custom color trim to window sashes and frames.

2. Description of the Related Art

In the past, colors have been applied to window frames in the form of paint, usually by the time-intensive and labor-intensive method of using a paint brush. Metal or plastic window frames have been prepare on site by cutting, bending, and joining pieces of the preferred material. Until now, preformed pieces of material have not been available for the installation or replacement of custom frames in a variety of colors.

### BRIEF SUMMARY OF THE INVENTION

The present invention relates to windows, broadly, and colored, custom-made plastic moldings for window sashes and frames in particular. The moldings of the present invention may be applied to the windows originally installed or may be replacements for previously installed moldings of this invention. The moldings of the present invention may come in custom colors thus providing colorful windows which do not require painting. The moldings may be replaced as the owners desire different colors on the houses. The moldings snap into place and provide simple installation. The moldings are simple to make in that they may be made of extruded plastic of a custom color and may be cut to the desired size and joined by conventional methods.

### BRIEF DESCRIPTION OF THE SEVERAL VIEWS OF THE DRAWINGS

FIG. 1 is a vertical cross-sectional view of a sill section of the window frame of the inventors' prior invention.

FIG. 2 is a vertical cross-sectional view of a head section of a window frame according to the inventors' prior invention.

FIG. 3 is a horizontal cross-sectional view of a jamb section of a window frame according to the inventors' prior invention.

FIG. 4 is an elevational perspective view of a sash molding according to this invention.

FIG. 5 is an elevational perspective view of the sash molding of this invention fitted onto a window sash of the inventors' prior invention.

FIG. 6 is an elevational perspective view of a frame molding of this invention.

FIG. 7 is an elevational perspective view of the frame molding of this invention fitted onto a window frame of the inventors' prior invention.

FIG. 8 is an elevational perspective view, partly in cross section, of a window containing the moldings of the present invention.

### DETAILED DESCRIPTION OF THE INVENTION

The molding of the present invention may easily be made to custom fit a wide variety of window frames and sashes. For simplicity, these moldings will be described with reference to the frames of the inventors' prior invention described in Ser. No. ______ filed ______, which description is set forth below.

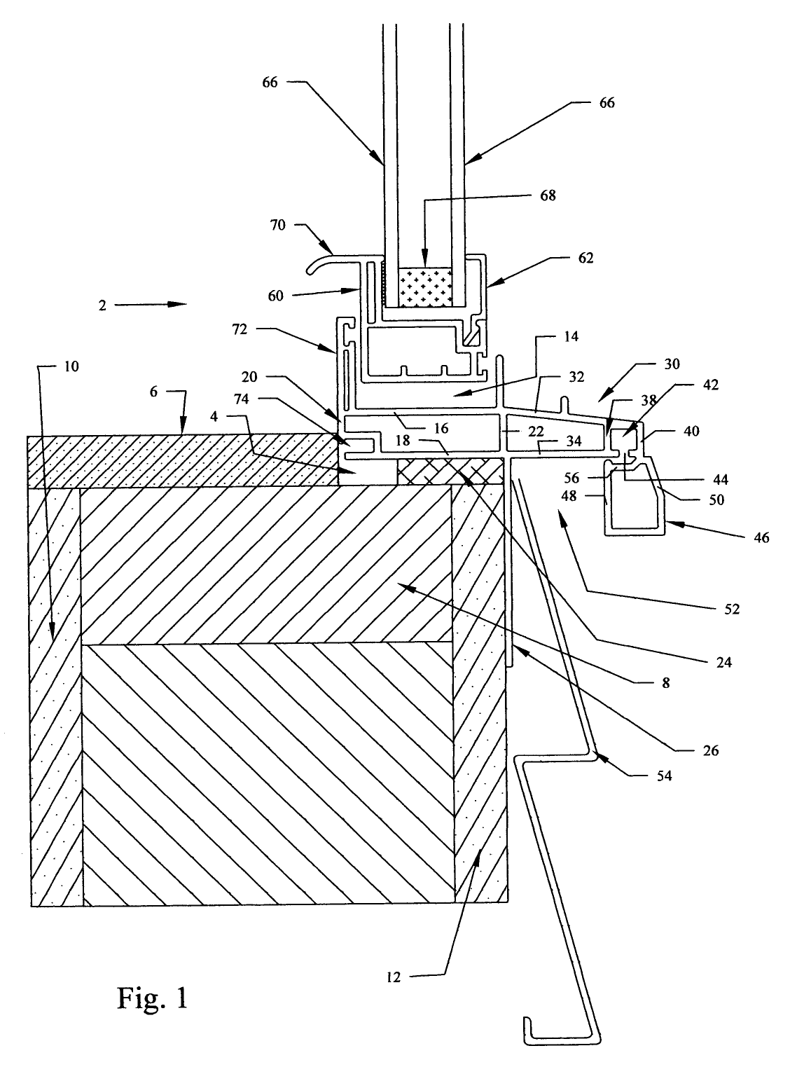

Referring to FIG. 1, an operable window assembly or unit 2 is shown installed in a rectangular rough opening 4 of a building wall 6 with the rough opening 4 defined at the bottom by wood frame members 8. In a typical construction, the interior of the wall 6 is formed by drywall sheets 10, and the exterior surface of the wall 6 is formed by exterior sheeting 12 also secured to the wall framing members 8. The window unit 2 includes an elongated linear sill member 14 which is formed as a hollow or tubular extrusion, preferably of a rigid plastic material such as polyvinylchloride (PVC).

The sill member 14 includes a horizontal inner wall 16 and a generally parallel and laterally spaced outer wall 18. The walls 16, 18 are integrally connected by laterally extending inner 20 and outer 22 transverse walls to provide the sill member 14 with a hollow box-like rigid construction. The outer wall 18 of the sill member 14 rests upon a spacer or shim strip or pad 24 which is placed within the rough opening 4, and a nailing flange 26 projects laterally outwardly or downwardly for securing the sill member 14 of the window frame unit 2 to the wall 6 by means of longitudinally spaced screws or nails.

The sill member 14 is connected to an integrally extruded exterior arm 30 which contains laterally spaced inner 32 and outer 34 walls. The inner wall 32 projects outwardly and downwardly from the exterior transverse wall 22 and the outer wall 34 projects outwardly and horizontally from the exterior transverse wall 22. The inner 32 and outer 34 walls of the exterior arm 30 are integrally connected by laterally extending first 22, second 38, and third 40 transverse walls to provide the exterior arm 30 with a hollow box-like rigid construction. The first wall 22 is the outer transverse wall of the sill member 14. The second wall 38 and the third wall 40, in cooperation with the inner 32 and outer wall 34, form a hollow box 42 having a partially open outer surface, which opening will be an accessory groove 44, when so needed.

An integrally extruded flange 46 having substantially parallel spaced walls 48, 50 depends from the exterior arm 30. The double-walled flange 46 cooperates with the opposing transverse wall 22 and the inner wall 48 of the exterior arm 30 to define a longitudinally extending recess or channel 52 located laterally outwardly of the outer wall 18 of the sill member 14. The flange 46 covers or conceals the upper edge portion of the siding 54, and the channel 52 allows for vertical expansion and contraction of the siding 54.

The outer wall 50 of the flange 46 is connected to the third transverse wall 40 of the exterior arm 30. The inner wall 48 of the flange 46 connects to a top cover 56 of the flange 46, which cover 56 connects with the third transverse wall 40 of the exterior arm 30. The exterior accessory groove 44 is made available by simply applying horizontal pressure to the flange 46, which pressure is in a direction away from the building wall 6. This breakaway feature allows a covering flange 46 to be available when needed or an accessory groove 44 to be available when needed.

The operable window unit 2 shown in FIG. 1 is also illustrated with an extruded PVC sash member 60 which forms the bottom of a sash 62 having welded mitered corners and enclosing a glass unit 64 with dual glass panes 66 sealed together by a resilient rubber-like bonding material 68. The bottom sash member 60 has an interior projecting lift rail or handle 70 and a double-wall flange 72 is extruded as an integral part of the sill member 14 and projects upwardly from the inner wall 16.

An interior accessory groove 74 is extruded within sill member 14 at the juncture of the outer wall 18 and the interior transverse wall 20. This accessory groove 74 is not needed to install the window frame unit 2 of this invention, and will be hidden when the window frame is installed as shown in FIG. 1. The accessory groove 74 is available if needed. It is seen that the window frame unit 2 of the present invention allows for a much simpler installation than prior art frames.

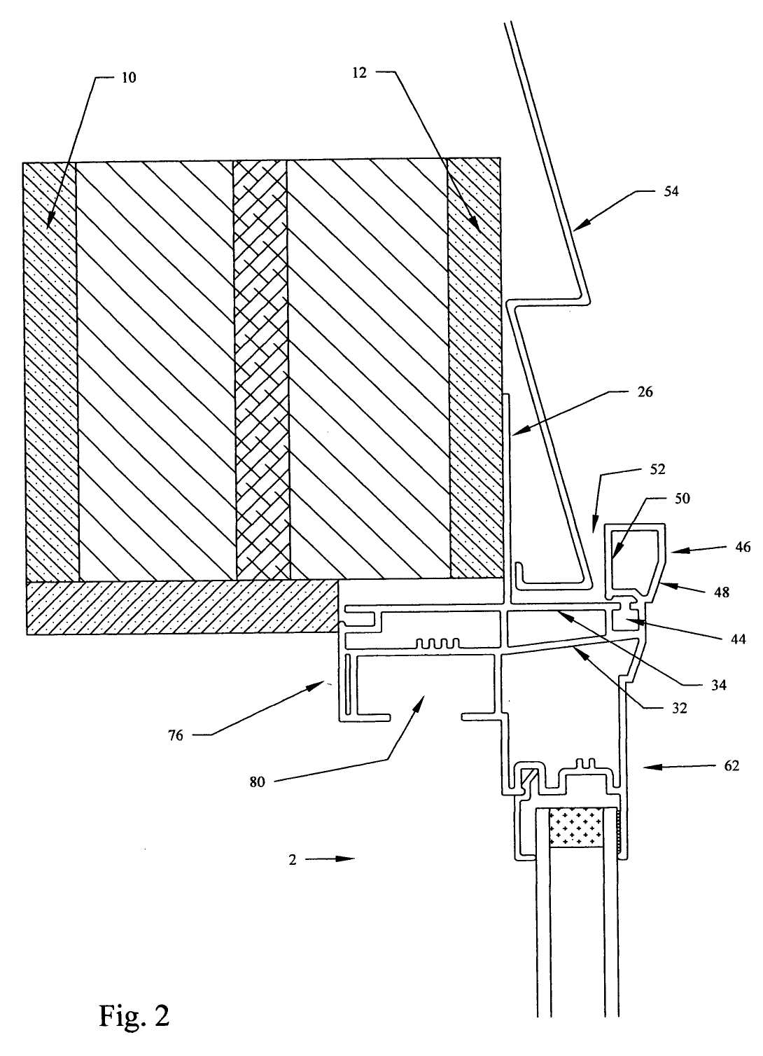

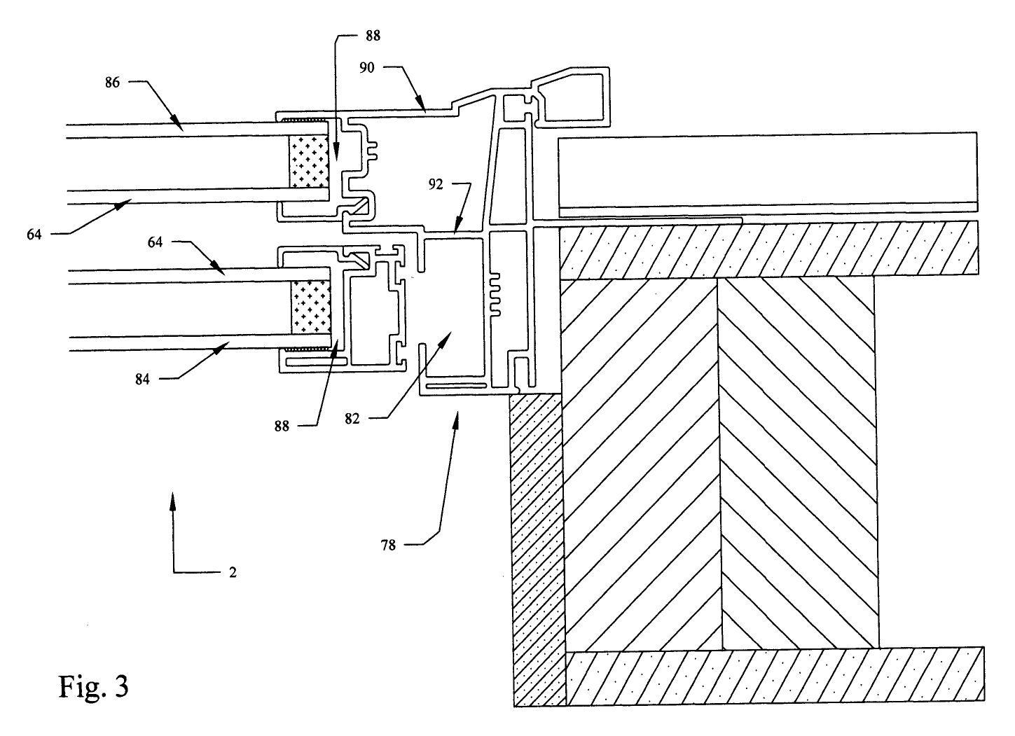

Referring to FIGS. 2 and 3, the frame unit 2 includes a head member 76 shown in FIG. 2 and a pair of vertical jamb members 78, one of which is shown in FIG. 3. Since the head member 76 and each jamb member 78 have outer structures which are common to that of the sill member 14, the same reference numbers have been used for the same corresponding walls and components. The head member 76 and each jamb member 78 also include a set of integrally extruded C-shaped channel portions 80, 82 which provide guide rails or tracks for the lower 84 and the upper 86 vertically moveable sash frames. The channel portions 88, shown in FIG. 3 of the jamb member 78 also enclose conventional spring bias counterbalancing mechanisms (not shown) for each movable sash frame 84, 86 and the enclosed glass units 64. These channel portions 88 are supported by outer 90 and inner 92 walls attached to, and integrally extruded with, the jamb members 78.

With further reference to FIG. 1, the sash 62 contains an upper 94 and lower 96 sections separated by an abutment line 98. The sash 62 contains an upper surface 100 abutting the outer glass pane 66.

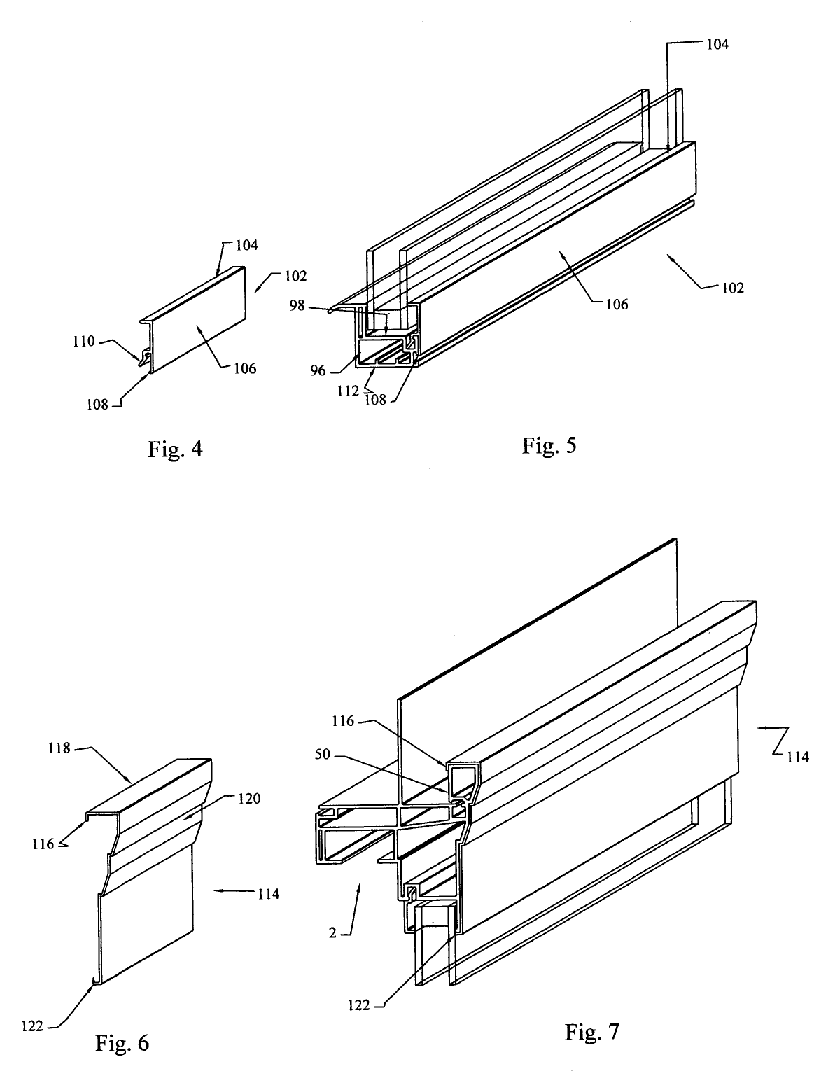

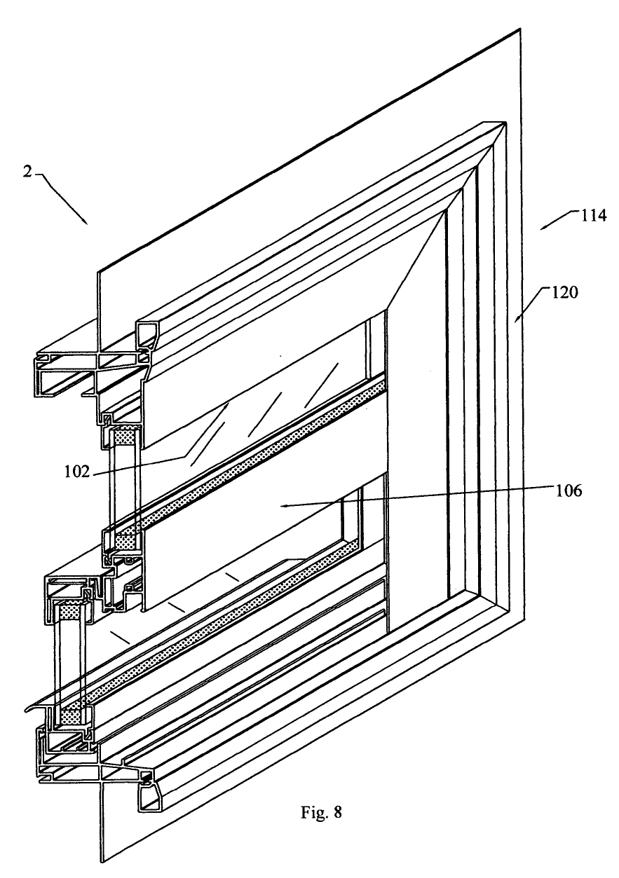

With reference to FIG. 4, the sash molding 102 of the present invention is a longitudinal strip of predetermined size containing a horizontal top ledge 104, an integral vertical exterior wall 106 ending in a slightly inwardly extending lower flange 108, and an inwardly and downwardly curved connection piece 110. The sash molding 102 is manufactured by extruding colored plastic material. Therefore, the entire sash 102 is made of colored material and the color will not be affected by chipping the sash 102.

The connection of the sash molding 102 to the sash 62 will be described with reference to FIG. 5. For connection of the window sash molding 102 to the window sash 62 of the inventors' prior invention, the horizontal top ledge 104 of the window sash molding 102 fits on top of the upper surface 100 of the window sash 62 abutting the outer window glass panes 66. The curved connection piece 110 fits into an abutment line 98 between the upper 94 and lower 96 sash sections by applying slight pressure against the connection piece 110. The sash molding 102 is then snapped into place. When the sash molding 102 is in place, the inwardly extending lower flange 108 abuts the lower surface 112 of the window sash 62. The sash molding 102 is thus held in place with the vertical exterior wall 106 covering the window sash 62. The sash molding 102 may be easily removed by pulling the molding 102 away from the sash 62.

With reference to FIG. 6, the frame molding 114 of the present invention is a longitudinal strip of predetermined size and color containing a vertical upper flange 116, a horizontal top ledge 118, and an integral exterior wall 120 ending in an inwardly extending flange 122. The exterior wall 120 is substantially vertical having a slight inward slant following that of the contour of the underlying frame unit 2. Note that the directions given above are with reference to the lowermost horizontal piece or sill. Absolute directions of the corresponding sections will, of course, vary depending on whether jambs or overhead pieces are being discussed.

The connection of the frame molding 114 to the window frame 2 will be discussed with reference to FIG. 7. The frame molding 114 is simple to connect to the window frame unit 2. The vertical flange 116 is placed in abutment with the inner parallel wall 48 of the extruded flange 46 of the frame unit 2 and the molding 114 is then moved so that tension in applied upwardly, outwardly, downwardly, and inwardly until the inwardly extending flange 122 of the molding 114 snaps onto the frame unit 2 and the molding 114 is held in place by snap fit. The frame molding 114 may be removed by pulling.

According to the present invention, a sash 102 or frame 114 molding having one color may be substituted for a molding 102, 114 having another color by simply removing the first molding 102, 114 and applying the second molding 102, 114. No scraping or painting is necessary. The new molding 102, 114 may be applied by preparing the new molding 102, 114 off site and snap fitting the molding to the sash 62 or frame 2 on site.

The moldings 102, 114 are preferably delivered on site in ready-to-use form. They may be delivered as strips which may be applied as such to the sashes 62 and frames 2. When such is the case, the ends of the strips may be connected by welding or other conventional methods. In the preferred mode, closed figures making up the moldings 102, 114 may be snap fitted to the existing sashes 62 or frames 2. The closed figures are preferably rectangular in shape. The moldings 102, 114 will be of uniform color throughout.

Although the invention has been described and illustrated in detail, it is to be clearly understood that the same is by way of illustration and example, and is not to be taken by way of limitation. The spirit and scope of the present invention are to be limited only by the terms of the appended claims.

1. A molding for covering a window sash, comprising a longitudinal strip containing a horizontal top ledge, an integral vertical exterior wall ending in an inwardly extending flange, and an inwardly and downwardly curved connection piece extending from the exterior wall.

2. The molding of claim 1, wherein the molding is made of colored plastic.

3. The molding of claim 2, wherein the molding is a closed figure having the shape of a predetermined window sash.

4. A molding for covering a window frame, comprising a longitudinal strip containing a vertical upper flange, a horizontal top ledge, and an integral exterior wall ending in a lower inwardly extending flange.

5. The molding of claim 4, wherein the exterior wall is substantially vertical having a slight inward slant following that of a predetermined underlying frame.

6. The molding of claim 5, wherein the molding is made of colored plastic.

7. The molding of claim 4, wherein the molding is a closed figure having the shape of a predetermined window frame.
